(19) United States
(12) Patent Application Publication
(10) Pub. No.: US 2013/0261043 A1
(43) Pub. Date: Oct. 3, 2013

(54) Detergent Composition

(71) Applicants: Irene Bello, Mira (IT); Fabio Costiniti, Mira (IT); Laura Roscioli, Mira (IT); Simone Scoizzato, Mira (IT); Ralf Wiedemann, Mira (IT)

(72) Inventors: Irene Bello, Mira (IT); Fabio Costiniti, Mira (IT); Laura Roscioli, Mira (IT); Simone Scoizzato, Mira (IT); Ralf Wiedemann, Mira (IT)

(73) Assignee: Reckitt Benckiser N.V., Hoofddorp (NL)

(21) Appl. No.: 13/883,345

(22) PCT Filed: Nov. 18, 2011
(86) PCT No.: PCT/GB2011/052264

§ 371 Date: Jun. 21, 2013

(30) Foreign Application Priority Data
Nov. 25, 2010 (GB) 1019988.3

(51) Int. Cl. C11D 1/722

(52) U.S. Cl. CPC C11D 1/722
USPC 510/356; 510/506; 568/613

(57) ABSTRACT

A composition comprises a surfactant having the formula below,

R¹(EtO)ₓ(PrO)_{y}(BuO)_{z}
R¹ is C₁₂₋₁₅.
X is 5-8.
Y is 0-4.
Z is 0-2.

This invention relates to a cleaning composition.

Cleaning compositions are commonly available. They are typically used for cleaning surfaces, e.g. kitchen/bathroom floors and work surfaces and also for textile surfaces such as clothing/fabric.

To achieve their aim cleaning compositions generally comprise a variety of different agents acting in conjunction with one another to achieve the overall cleaning goal. This is because most stains comprise a variety of different compounds, each of which requiring a different means of treatment for effective removal.

For example certain stains such as those based on food proteins and starches require enzymes for effective removal. Coloured stains from food dyes require bleaches for removal. Stains based on greases and fats require surfactants for removal.

Generally each type of cleaning composition agent is only able to act on one type of stain in a limited fashion.

It is an object of the present invention to obviate/mitigate the disadvantages described above.

According to a first aspect of the present invention, there is provided a composition comprising a surfactant having the formula below,

R¹(EtO)ₓ(PrO)_{y}(BuO)_{z}
R¹ is C₁₂₋₁₅,
X is 5-8,
Y is 0-4,
Z is 0-2.

Here it has been found that the cleaning composition is surprisingly advantageous. The advantages are shown in the way that certain stains are addressed. More specifically it has been found that using the composition of the invention stains which are normally deemed to be bleachable” can be more effectively addressed than has been previously observed with other surfactants. Without wishing to be bound by theory we believe that the reason for this behaviour is related to the wetting effect of the surfactants: this aids the action of the bleaching system in the stain, boosting its effect.

The invention is also directed to the use of the above-described composition as a laundry booster, stain treater, laundry detergent, etc.

Preferably the amount of surfactant present in the composition is from 0.1 to 10 wt %, more preferably from 0.1 to 5 wt %, more preferably from 0.1 to 3 wt % and most preferably about 1.5%

Most preferably the surfactant is selected from C₁₂₋₁₄, 6-8EO & 2-4PO; C₁₃₋₁₅, 5 EO & 2 BO.

### Additional Surfactant

The preferred compositions also contain from about 0.05% to about 15% of a C₈-C₁₈ alcohol alkoxylated with 3 to 6 moles of ethylene oxide. A wide variety of alkoxylated fatty alcohols are known to the art and these vary considerably in HLB (hydrophile-lipophile balance). For purposes of this invention, it is preferable to employ an alkoxylated alcohol which is relatively hydrophobic. Preferred surfactants are fatty alcohols having from about 8 about 15 carbon atoms, alkoxylated with about 4 to 6 moles of ethylene oxide. A particularly preferred surfactant is that sold under the trademark Slovasol 25-5 and has a formulation of C₁₂-C₁₅ alcohols alkoxylated with 5 moles of ethylene oxide. These nonionic surfactants are preferably present in the compositions of this invention in amounts ranging from 0.1% to 2%, more preferably from 0.3% to 1%.

### Other

To bring the pH to within the desired range of a sufficient amount of an acid or an alkali is added to adjust the pH.

The compositions of this invention desirably also contain at least one organic solvent which is preferably water-miscible. Such useful organic solvents include: the linear alcohols such as ethanol, isopropanol and the isomers of butanol; diols; glycols such as ethylene glycol, propylene glycol and hexylene glycol; glycol ethers, etc. Low molecular weight solvents, i.e. those from 1 to 8 carbon atoms, are preferred. A particularly preferred solvent is propylene glycol.

The composition additionally comprises up to 10% wt, 8% wt, 6% wt, 4% wt, 2% wt, 1% wt or 0.5% wt of minor ingredients selected from one or more of the following: dye, fragrance, preservative, optical brightener, antibacterial agent, dye transfer inhibitor or a bittering agent.

In order to provide desirable rheologic characteristics to the composition of this invention, thickeners should be added. These include polymeric substances which function as viscosity stabilizers and aid in enzyme stabilization. Exemplary of such polymeric compositions are polyacrylic acid, polymethacrylic acid, acrylic/methacrylic acid copolymers, hydrolyzed polyacrylamide, hydrolyzed polymethacrylamide, hydrolyzed polyacrylonitrile, hydrolyzed polymethacrylonitrile, etc. Water soluble salts or partial salts of these polymers, as well as their respective alkali metal or ammonium salts can also be used. A preferred polymeric substance is sold under the trademark Polygel DA, which is a polyacrylic acid having a molecular weight greater than 1,000,000. These polymers are used in amounts ranging from about 0.1% to 1%, preferably about 0.4%.

A preferred thickening agent is xanthan gum which may be present in an amount of from between 0.1% and 0.5%, preferably about 0.3%. In addition to providing beneficial viscosity characteristics to the compositions, xanthan gum also assists in the removal of certain stains.

Cellulose derivatives such as hydroxyethyl cellulose, may be used as thickeners as can (co)polymeric thickeners, e.g. those based on acrylates, such as Polygel W301 from 3V Sigma.

Additionally the desired viscosity may be achieved though the use of surfactants/combination of surfactants, e.g. with the surfactants of the invention.

Bleaches may be present in the composition. Examples of bleaches that may be used are oxygen bleaches.

Peroxygen bleaching actives are: perborates, peroxides (e.g. hydrogen peroxide), peroxyhydrates, persulfates. A preferred compound is sodium percarbonate and especially the coated grades that have better stability. The percarbonate can be coated with silicates, borates, waxes, sodium sulfate, sodium carbonate and surfactants solid at room temperature. For liquid compositions the bleach is preferably peroxide bleach, most preferably hydrogen peroxide. Peroxide sources other than H₂O₂ can be used.

Optionally, the compositions may additionally comprise from 0.01 to 30% wt, preferably from 2 to 20% wt of bleach precursors. Suitable bleach precursors are peracid precursors, i.e. compounds that upon reaction with hydrogen peroxide product peroxyacids. Examples of peracid precursors suitable for use can be found among the classes of anhydrides, amides, imides and esters such as acetyl triethyl citrate (ATC), tetra acetyl ethylene diamine (TAED), succinic or maleic anhydrides.

Suitable preservatives include the isothiazolinones sold under the trademark Kathon DP3 and available from Rohm & Haas.

The compositions may also comprise suspended particles which differ in colour or shade from the aqueous liquid composition. These particles (speckles) can serve an aesthetic purpose. Speckles can be present in amounts ranging from about 0.01 to about 1.0 weight percent. Typically, they will consist of a solid material which can function as an additional stabilizing agent, a coating which melts at a suitable temperature, and a small amount of dye.

The amount of water present in the composition is at least 50% wt, 60% wt, 70% wt or 80% wt.

The invention will be illustrated with reference to the following non-limiting Examples.

### EXAMPLES

### Products

### A—Liquid

| Raw Materials | (wt %) |
|---|---|
| water | 59.8 |
| NaOH 50% | 2.0 |
| Anionic Surfactant | 7.0 |
| Nonionic Surfactant | 12.4 |
| H₂O₂ Stabiliser | 0.2 |
| H₂O₂ 50% | 16.0 |
| Fragrance | 0.2 |
| Antioxidant | 0.025 |
| Dye | 0.8 |
| C₁₂₋₁₄, 6-8EO, 2-4PO Surfactant | 1.5 |

### B—Granular

| Raw Materials | (wt %) |
|---|---|
| Sodium carbonate | 39.3 |
| Sodium silicate | 2.0 |
| Sodium sulphate | 10.0 |
| Sodium percarbonate | 40.0 |
| TAED | 3.8 |
| Anionic Surfactant | 2.0 |
| Zeolite | 0.2 |
| Enzyme | 1.0 |
| C₁₂₋₁₄, 6-8EO, 2-4PO Surfactant | 1.5 |

### Performance

The following reagents were prepared.?

| | | Detergent Dosage |
|---|---|---|
| Ref | Product | (g/wash) |
| 1 | Laundry detergent powder (PCB | 80 |
| | and TAED containing) + 100 ml | |
| | Product B | |
| 2 | Laundry detergent powder (PCB | 80 |
| | and TAED containing) + 100 ml | |
| | Product B* | |

*comparative product B: a nonionic surfactant outside the scope of the invention was used at the same level.

The washing conditions used tap water at 25° F. hardness, 40° C. washing under a standard cotton cleaning program in a front-loading European washing machine, using 3.5 kg of new and clean cotton ballast, with four replications. Final drying in a tumble drier and ironing of technical swatches. Instrumental evaluation via spectrophotometer (Y value).

The results show that the composition of the invention achieves parity performance on; blueberry juice, curry, ketchup, lipstick, make-up, olive oil, mayonnaise, sebum, motor oil, spaghetti sauce, clay, beef fat, mustard, chocolate, chocolate ice cream, spinach, cocoa, grass; and superior performance on; blackberry juice, tomato, tea, wine, coffee, soy sauce.

1. A composition comprising a surfactant having the formula:
R¹(EtO)ₓ(PrO)_{y}(BuO)_{z}
wherein:
R¹ is C₁₃₋₁₅,
X is 5-8,
Y is 0
Z is 2.

2. A composition according to claim 1, wherein the amount of surfactant present in the composition is from 0.1% wt. to 10% wt.

3. (canceled)

4. (canceled)

5. A laundry/fabric washing operation which comprises the step of:
utilizing a composition according to claim 1 during the said operation.

6. A laundry/fabric washing operation according to claim 5, wherein the composition comprises the surfactant in an amount of from 0.1% wt. to 10% wt.

7. A method of treating bleachable stains in a laundry/fabric washing operation, which operation comprises the step of:
contacting the bleachable stain with a composition according to claim 1 during the said operation.

8. A method according to claim 7, wherein the composition comprises the surfactant in an amount of from 0.1% wt. to 10% wt.

9. A composition according to claim 1 which is a textile pretreatment composition.
